(19) United States
(12) Patent Application Publication
(10) Pub. No.: US 2010/0296895 A1
(43) Pub. Date: Nov. 25, 2010

(54) LOST COST/HIGH PERFORMANCE BLIND FASTENER

(75) Inventors: GARY G. CASSATT, Derby, KS (US); DINH Q. VU, Wichita, KS (US); ROBERT J. MOCK, Wichita, KS (US)

Correspondence Address: OSTRAGER CHONG FLAHERTY & BROITMAN, P.C., 570 LEXINGTON AVENUE, FLOOR 17, NEW YORK, NY, 10022-6894, US

(73) Assignee: THE BOEING COMPANY, Chicago, IL (US)

(21) Appl. No.: 12/848,446

(22) Filed: Aug. 2, 2010

Related U.S. Application Data
(63) Continuation of application No. 11/379,710, filed on Apr. 21, 2006.

(51) Int. Cl. F16B 35/00; F16B 21/00

(52) U.S. Cl. 411/337; 411/500

(57) ABSTRACT

A blind fastener is provided comprising a core bolt comprised of a bolt shaft and a bolt head. A metal sleeve is included comprising a rigid cylindrical base and a malleable cylindrical tail, the metal sleeve is positioned around the bolt shaft with the malleable cylindrical tail in communication with the bolt head. A travel stop feature is formed on the rigid cylindrical base opposite the malleable cylindrical tail. A drive feature includes a threaded bolt section extending from a foot end of the bolt shaft and a drive nut rotatably thereto. The drive nut allows the core bolt to be pulled within the metal sleeve such that the bolt head compresses the malleable cylindrical tail to form a retention button.

### RELATED APPLICATIONS

This application is a continuation of application Ser. No. 11/379,710 filed Apr. 21, 2006, the disclosure of which is incorporated herein by reference.

### TECHNICAL FIELD

The present disclosure relates generally to a low cost and high performance blind fastener, and, more particularly to blind fastener utilizing a malleable tail for retention button formation.

### BACKGROUND

Aircraft manufacturing commonly relies on the ability to assemble complex assemblies within tight space limitations. As such, many manufacturing and assembly procedures require that parts must be installed and fastened together from only one side. To further complicate matters, the ever increasing prevalence of composite structures within the aircraft are often unsuitable for traditional fastening methodologies such as rivets wherein the composite structures may sustain damage during the fastening procedure.

As such, the use of blind fasteners, or fasteners that install from only one side, has been commonplace in aircraft manufacturing for many years. Existing blind fasteners, however, are often limited in strength or are heavy and expensive in comparison to solid shank fasteners. Close out structure designs in highly loaded areas must compensate for performance limits with heavier structures and increased numbers of fasteners. This generates undesirable cost increase, increases in manufacturing time, and negatively impacts the weight savings that commonly drive aircraft design. What is needed is a design that incorporates the cost effectiveness and performance characteristics of solid shank fasteners (such as traditional bolt assemblies) with the unique installation benefits of blind fasteners.

It would, however, be highly desirable to have a blind fastener that incorporated the cost effective and positive performance of solid shank fasteners in a blind fastener design. Similarly, it would be highly desirable to have a blind fastener that was suited to handle the joining of composite structures without sacrificing fastening strength.

### SUMMARY

A blind fastener is provided comprising a core bolt comprised of a bolt shaft and a bolt head. A metal sleeve is included comprising a rigid cylindrical base and a malleable cylindrical tail, the metal sleeve is positioned around the bolt shaft with the malleable cylindrical tail in communication with the bolt head. A travel stop feature is formed on the rigid cylindrical base opposite the malleable cylindrical tail. A drive feature includes a threaded bolt section extending from a foot end of the bolt shaft and a drive nut rotatably thereto. The drive nut allows the core bolt to be pulled within the metal sleeve such that the bolt head compresses the malleable cylindrical tail to form a retention button.

Other features of the present disclosure will become apparent when viewed in light of the detailed description of the preferred embodiment when taken in conjunction with the attached drawings and appended claims.

### BRIEF DESCRIPTION OF THE DRAWINGS

FIG. 1 is an exploded view illustration blind fastener in accordance with the present disclosure;

FIG. 2 is an illustration of the blind fastener illustrated in FIG. 1, the blind fastener shown inserted through a first joinable element and a second joinable element;

FIG. 3 is an illustration of the blind fastener illustrated in FIG. 1, the blind fastener illustrated forming a retention button; and

FIG. 4 is an illustration blind fastener illustrated in FIG. 1, the illustration showing the use of a break-neck feature on the drive feature.

### DESCRIPTION OF THE PREFERRED EMBODIMENT(S)

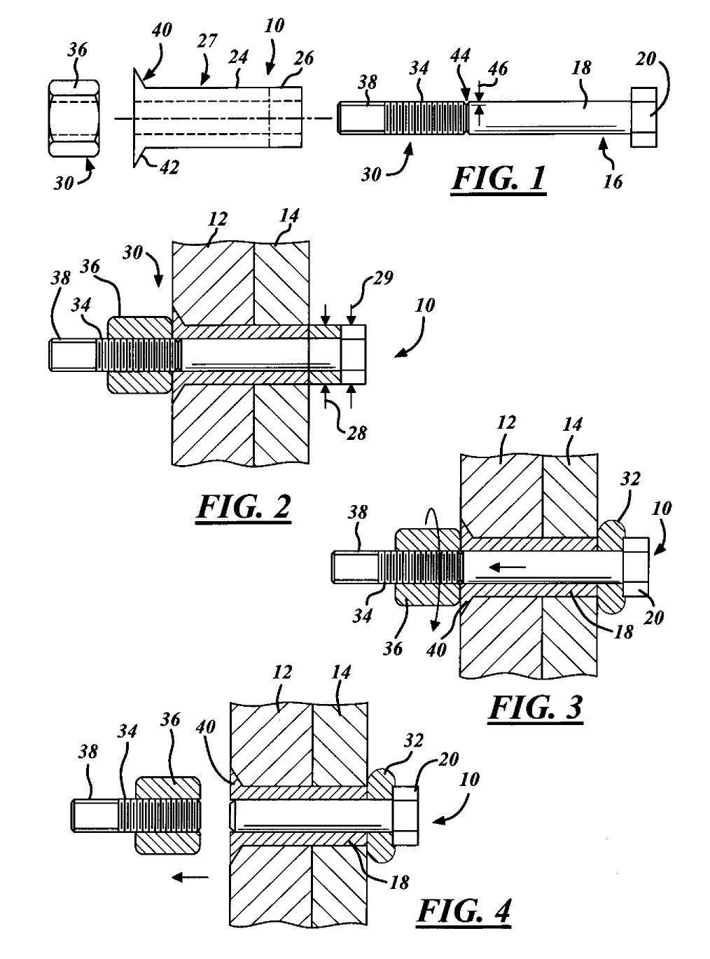

Referring now to FIG. 1, which is an illustration of a blind fastener 10 in accordance with the present disclosure. The blind fastener 10 was developed to join a first joinable element 12 to a second joinable element 14 while only requiring access from a single side. The embodiments set forth herein were developed specifically for aircraft and aerospace applications, although a variety of alternate uses will become apparent in view of the present disclosure. Although the first and second joinable elements 12, 14 may be any of a wide variety of elements and may be composed of a wide variety of materials, in one embodiment it is contemplated that the first joinable element be comprised of a metal panel and the second joinable element 14 be composed of a composite panel. Joining composites to metals often gives rise to assembly difficulties due to the inappropriateness of metal fasteners such as rivets to composites.

The disclosed blind fastener addresses these and other blind fastening (from a single side) issues through the use of a blind fastener 10 comprised of a core bolt 16 made up of a bolt shaft 18 and a bolt head 20. The core bolt 16 is preferably comprised of a metal alloy, although a wide variety of materials may be utilized. The blind fastener 10 further comprises a metal sleeve 22, preferably cylindrical, configured to surround the bolt shaft 18 with the bolt shaft 18 inserted through the sleeve 22. The metal sleeve 22 includes two cylindrical in-line sections. The first is a rigid cylindrical base 24 configured of a material sufficiently strong to withstand fastening loads. The second is a malleable cylindrical tail 26. The rigid cylindrical base 24 and the malleable cylindrical tail 26 preferably share the same sleeve outer diameter 28. In addition, it is contemplated that the sleeve outer diameter 28 be substantially the same as the bolt head outer diameter 29. The malleable cylindrical tail 26 is preferably in communication with the bolt head 20 when the metal sleeve 22 is positioned around the bolt shaft 18. It is also preferred that the malleable cylindrical tail 26 is permanently affixed to the bolt head 20 such as through bonding, brazing, welding, spin welding, or frictional welding. Although a number of permanent attachment methodologies have been described, a wide variety are contemplated.

The blind fastener 10 further includes a drive feature 30 positioned on the bolt shaft 18 opposite the bolt head 20 to provide a means for the core bolt 16 to be pulled within the metal sleeve 22 such that the bolt head 20 exerts a compressive force on the malleable cylindrical tail 26. The blind fastener 10 is inserted through the joinable elements 12, 14 (see FIG. 2) and the drive feature 30 is used to exert the compressive force. Upon exerting the compressive force, the bolt head 20 compresses the malleable cylindrical tail 26 until it forms a retention button 32 (see FIG. 3). The malleable cylindrical tail 26 is preferably formed from an alloy that becomes work hardened as the retention button 32 is formed. In this fashion the retention button is formed on a remote side of the joinable elements 12, 14 without requiring installation access. The malleable cylindrical tail 26 may be formed from a variety of materials. However, in two specific embodiments contemplate the use of titanium-columbium or aluminum alloys.

Although a generic drive feature has been described, one embodiment contemplates the use of a drive feature 30 comprised of a threaded bolt section 34 extending from the bolt shaft 18 and a drive nut 36 engaged thereto, By torquing on the drive nut 36, the desired compressive force may be exerted onto the core bolt 16 in order to begin compression of the malleable cylindrical tail 26. A wrench flat 38 feature formed on the trailing end of the threaded bolt section 34 allows the core bolt 16 to be rotationally held while the drive nut 36 is turned. A travel stop feature 40 is formed on the end of the rigid cylindrical base 24 in order to limit the insertion length of the blind fastener 10 and provides a countervailing load to the retention button 32 formation. This allows the joinable feature 12, 14 to be compressed between the travel stop feature 40 and the retention button 32. Although a variety of travel stop features 40 are contemplated, one embodiment contemplates the use of an outwardly flanged feature 42. This type of travel stop 40 is highly useful in engaging metal surfaces. The retention button 32, however, is suitable for a wide variety of surfaces including composites.

In addition to the aforementioned features, the present disclosure contemplates a few more additional novel characteristics. One such characteristic is the inclusion of a break neck groove 44, such as a v-groove. The break neck groove 44 is positioned between the drive feature 30 (threaded bolt section 34) and the bolt shaft 18. This allows the drive feature to be broken off after installation and formation of the retention button 32 (see FIG. 4). In addition, it is contemplated that the v-groove depth 46 and/or v-groove location 48 may be designed such that the break neck groove 44 breaks when the compressive force is sufficient to form the retention button 32. In this fashion, the retention button 32 can be formed simply and reliably while automating the removal of the drive feature 30.

While particular embodiments of the disclosure have been shown and described, numerous variations and alternative embodiments will occur to those skilled in the art. Accordingly, it is intended that the disclosure be limited only in terms of the appended claims.

1. A blind fastener in a fastened configuration comprising:
a core bolt having a shaft and a head;
a metal sleeve surrounding the bolt shaft, the shaft being inserted into the sleeve, the sleeve comprising a rigid cylindrical base configured of a material sufficiently strong to withstand fastening loads, in line with a retention button;
the retention button being adjacent to and permanently affixed to the bolt head;
the retention button having a solid, hardened, unfolded shape.

2. The blind fastener of claim 1, wherein the blind fastener further comprises:
a drive feature positioned on the bolt shaft opposite the bolt head.

3. The blind fastener of claim 2, wherein:
the drive feature comprises a threaded bolt section extending from the bolt shaft and a drive nut engaged thereto.

4. The blind fastener of claim 1, wherein:
the blind fastener further comprises a wrench flat feature formed on the trailing end of the threaded bolt section, allowing the core bolt to be rotationally held while the drive nut is turned.

5. The blind fastener of claim 1, wherein:
the blind fastener further comprises a travel stop feature formed on the end of the rigid cylindrical base in order to limit the insertion length of the blind fastener and provide a countervailing load to the retention button.

6. The blind fastener of claim 5, wherein:
the travel stop feature is an outwardly flanged, partially cone-shaped feature.

7. The blind fastener of claim 6, wherein:
the bolt head is sunk into the retention button.

8. The blind fastener of claim 7, wherein:
the retention button possesses a circular edge which is adjacent to and permanently affixed to the bolt head.

9. The blind fastener of claim 2, wherein:
the blind fastener further comprises a break neck groove positioned between the drive feature and the bolt shaft.

10. The blind fastener of claim 7, wherein:
the break neck groove is a v-groove.

11. A fastened joint, comprising:
a first joinable element defining a first hole;
a second joinable element defining a second hole, said first hole and said second hole being substantially aligned; and
a blind fastener comprising:
a core bolt having a shaft and a head;
a metal sleeve surrounding the bolt shaft, the shaft being inserted into the sleeve, the sleeve comprising a rigid cylindrical base configured of a material sufficiently strong to withstand fastening loads, in line with a retention button;
the retention button being adjacent to and permanently affixed to the bolt head;
the retention button having a solid, hardened, unfolded shape;
the core bolt and metal sleeve of the blind fastener being inserted through the first hole and second hole, said retention button being pressed against the second joinable element, thereby fastening the first joinable element to the second joinable element.

12. The fastened joint of claim 11, wherein the blind fastener further comprises:
a drive feature positioned on the bolt shaft opposite the bolt head.

13. The fastened joint of claim 12, wherein:
the drive feature comprises a threaded bolt section extending from the bolt shaft and a drive nut engaged thereto.

14. The fastened joint of claim 11, wherein:
the blind fastener further comprises a wrench flat feature formed on the trailing end of the threaded bolt section, allowing the core bolt to be rotationally held while the drive nut is turned.

15. The fastened joint of claim 11, wherein:
the blind fastener further comprises a travel stop feature formed on the end of the rigid cylindrical base in order to limit the insertion length of the blind fastener and provide a countervailing load to the retention button, said travel stop feature being pressed against the first joinable element, thereby holding the blind fastener to the first joinable element.

16. The fastened joint of claim 15, wherein:
the travel stop feature is an outwardly flanged, partially cone-shaped feature.

17. The fastened joint of claim 16, wherein:
the bolt head is sunk into the retention button.

18. The fastened joint of claim 17, wherein:
the retention button possesses a circular edge which is adjacent to and permanently affixed to the bolt head.

19. The fastened joint of claim 12, wherein:
the blind fastener further comprises a break neck groove positioned between the drive feature and the bolt shaft.

20. The fastened joint of claim 17, wherein:
the break neck groove is a v-groove.
